(19) United States
(12) Patent Application Publication
(10) Pub. No.: US 2026/0187242 A1
(43) Pub. Date: Jul. 2, 2026

(54) SYSTEM AND METHOD FOR CREATING SOFTWARE COMPONENTS CAPABLE OF SHARING STATE ACROSS THREADS IN A THREAD-ISOLATED EXECUTION ENVIRONMENT

(71) Applicant: Microsoft Technology Licensing, LLC, Redmond, WA (US)

(72) Inventors: Sander SAARES, Tartu (EE); Martin TAILLEFER, Redmond, WA (US)

(73) Assignee: Microsoft Technology Licensing, LLC, Redmond, WA (US)

(21) Appl. No.: 19/002,046

(22) Filed: Dec. 26, 2024

(51) Int. Cl. G06F 21/55; G06F 21/53

(52) U.S. Cl. CPC G06F 21/556; G06F 21/53

(57) ABSTRACT

A system and method for generating software components in a multithreaded processing environment that are capable of being executed in a thread-isolated manner to prevent data leakage across threads and that are linked together in a manner that enables the software components to share state includes generating a face template for a thread-specific face in a first thread and initializing a global variable that includes a global handle to a thread-local static variable. Thread-specific faces can then be initialized in threads from the face template. A thread-local static variable is lazy-initialized for each thread-specific face from the global variable in a manner that links the faces together to act as a single component.

### BACKGROUND

Thread-isolated execution refers to the design and implementation of multithreaded systems where each thread operates independently, with minimal or no interference from other threads. Thread-isolated execution is particularly important in concurrent programming, as it enhances fault tolerance, simplifies debugging, and promotes scalability in complex systems. However, even in thread-isolated components it is sometimes necessary to share state across threads with a peer component on another thread. Previously known methods for enabling sharing state across threads between components in a thread-isolated execution environment have typically required robust synchronization mechanisms, such as locks, semaphores, or barriers, which are complex and difficult to implement and can introduce performance overhead and the risk of deadlocks.

What is needed therefore is a system and method of generating software components capable of being executed in a thread-isolated execution environment with compile-time enforced safety guarantees that are also capable of sharing state with peer components across threads in a manner that does not adversely impact the performance or security of the execution environment.

### SUMMARY

In one general aspect, the instant disclosure presents a data processing system having a processor and a memory in communication with the processor wherein the memory stores executable instructions that, when executed by the processor alone or in combination with other processors, cause the data processing system to perform multiple functions. The functions include generating a face template for a type of thread-specific face of a component in a first thread of an application being executed in the multithread processing system; initializing a first thread-specific face in the first thread using the face template in response, the first thread-specific face having a first thread-specific state; initializing a first thread-local static variable for the first thread-specific face from a global variable in response to initialization of the first thread-specific face; allocating shared state for use with all faces generated from the face template in response to the initialization of the first thread-specific face; including a reference to the first thread-local static variable and a reference to the shared state in the first thread-specific face during initialization of the first thread-specific face in the first thread; initializing a second thread-specific face for the component in a second thread of the application based on the face template, the second thread-specific face having a second thread-specific state, initializing a second thread-local static variable for the second thread-specific face is initialized from the global variable in response to initialization of the second thread-specific face; and including a reference to the second thread-local static variable and the reference to the shared state in the second thread-specific face during initialization of the second thread-specific face in the second thread, wherein the reference to the first thread-local static variable in the first thread-specific face and the reference to the second thread-local static variable in the second thread-specific face form a link between the first thread-specific face and the second thread-specific face that enables the first thread-specific face and the second thread-specific face to act together as a single component, and wherein the first thread-specific face and the second thread-specific face are each executed in a thread-isolated manner to prevent thread-specific faces from accessing thread-specific states of other thread-specific faces so that data leakage across threads is prevented.

In yet another general aspect, the instant disclosure presents a method for generating software components in a multithreaded processing environment that are capable of being executed in a thread-isolated manner to prevent data leakage across threads and that are linked together in a manner that enables the software components to share state sharing state across threads in a multithreaded processing environment. The method comprises generating a face template for a type of thread-specific face of a component in a first thread of an application being executed in a multithread processing system; initializing a first thread-specific face in the first thread using the face template in response, the first thread-specific face having a first thread-specific state; initializing a first thread-local static variable for the first thread-specific face from a global variable in response to initialization of the first thread-specific face; creating a shared state for use with all faces generated from the face template in response to the initialization of the first thread-specific face; including a reference to the first thread-local static variable and a reference to the shared state in the first thread-specific face during initialization of the first thread-specific face in the first thread; initializing a second thread-specific face for the component in a second thread of the application based on the face template the second thread-specific face having a second thread-specific state; initializing a second thread-local static variable for the second thread-specific face is lazy-initialized from the global variable in response to initialization of the second thread-specific face; and including a reference to the second thread-local static variable and the reference to the shared state in the second thread-specific face during initialization of the second thread-specific face in the second thread, wherein the reference to the first thread-local static variable in the first thread-specific face and the reference to the second thread-local static variable in the second thread-specific face form a link between the first thread-specific face and the second thread-specific face that enables the first thread-specific face and the second thread-specific face to act together as a single component, and wherein the first thread-specific face and the second thread-specific face are each executed in a thread-isolated manner to prevent thread-specific faces from accessing thread-specific states of other thread-specific faces so that data leakage across threads is prevented.

In a further general aspect, the instant application describes a non-transitory computer readable medium on which are stored instructions that when executed cause a programmable device to perform functions of generating a face template for a type of thread-specific face of a component in a first thread of an application being executed in a multithread processing system; initializing a first thread-specific face in the first thread using the face template in response the first thread-specific face having a first thread-specific state; initializing a first thread-local static variable for the first thread-specific face from a global variable in response to initialization of the first thread-specific face; creating a shared state for use with all faces generated from the face template in response to the initialization of the first thread-specific face; including a reference to the first thread-local static variable and a reference to the shared state in the first thread-specific face during initialization of the first thread-specific face in the first thread; initializing a second thread-specific face for the component in a second thread of the application based on the face template the second thread-specific face having a second thread-specific state; initializing a second thread-local static variable for the second thread-specific face is lazy-initialized from the global variable in response to initialization of the second thread-specific face; and including a reference to the second thread-local static variable and the reference to the shared state in the second thread-specific face during initialization of the second thread-specific face in the second thread, wherein the reference to the first thread-local static variable in the first thread-specific face and the reference to the second thread-local static variable in the second thread-specific face form a link between the first thread-specific face and the second thread-specific face that enables the first thread-specific face and the second thread-specific face to act together as a single component, and wherein the first thread-specific face and the second thread-specific face are each executed in a thread-isolated manner to prevent thread-specific faces from accessing thread-specific states of other thread-specific faces so that data leakage across threads is prevented.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts a computing environment in which aspects of the disclosure may be implemented.

FIG. 2 depicts an example implementation of a software component that includes a thread-specific face generated in multiple threads of an application.

FIG. 3 is a diagram showing how a first thread-specific face of a component is generated in a thread of an application.

FIGS. 4A-4D are diagrams of different stages of generating an additional thread-specific faces based on the first thread-specific faces.

FIG. 5 is a diagram showing how thread-specific faces are linked via an intermediate layer comprising a global variable in which a thread-local static variable is initialized for the thread-specific faces of a component.

FIG. 6 is a flowchart of an example method of sharing state between threads in a multithreaded processing environment with compiler-enforced safety guarantees.

FIG. 7 is a block diagram of an example computing device, which may be used to provide implementations of the mechanisms described herein; and

FIG. 8 is a block diagram illustrating components of an example machine configured to read instructions from a machine-readable medium.

### DETAILED DESCRIPTION

Current techniques for achieving thread isolation rely on either a) error-prone manual labor to ensure no unintentional cross-thread access occurs or b) compiler-enforced single-threadedness guarantees, which prevent intentional sharing by forcing a component to exist on a single thread. Despite its benefits, completely isolating threads often leads to inefficiencies, as it is sometimes necessary that components on different threads can collaborate and share state across threads. Finding ways to enable sharing across threads that do not adversely impact the underlying system has posed significant challenges in the development of thread-isolated systems and components.

To address the technical problems associated with sharing data across threads in a thread-isolated execution environment having compile-time enforced safety and security guarantees, this description provides technical solutions in the form of a system and method of generating software components that are capable of being executed in thread-isolated execution environments with compile-time enforced safety and security guarantees and that have mechanisms for sharing data between components in different threads. The solutions described herein involve splitting a component into thread-specific “faces” which are connected by a hidden “link” embedded into each face. The term “face” is used to refer to iterations of a software component which are capable of being generated in different threads and/or the same thread as part of an application and that have thread-local storage and computation and at the same time include mechanisms for sharing state across threads in a thread-isolated execution environment. Individual faces can operate completely independently of each other, enabling maximal performance. The faces have access to shared state and are linked together using thread-local static variables in a manner that enables the faces to act as a single component. Only when it is strictly necessary do the faces interact with one another through the global state. This is what makes this design innovative. It makes it natural to have these per-thread faces on top of global data, and these faces provide a place to store thread-local state and perform thread-local computation to minimize access to the global state. Existing systems just provide raw access to the shared state to each thread, so they don’t have the benefit of this isolated compute and state. Collaborating peer components (i.e., faces) on other threads are created by obtaining a “handle”, which is a thread-safe payload that may be used to create a new face on a different thread. From the point of view of the system, each face represents a separate component and is treated as such. Each face is marked for the compiler as a single-threaded type, enabling compile-time protection against accidental data leakage across threads.

The mechanisms described herein provide facilities to easily create the linked components using traditional “constructor” patterns while allowing the author of the component to decide which parts of the component are thread-isolated and which are shared. The mechanism can allow linked components that are being executed in a thread-isolated manner to be treated as regular non-thread-isolated components by the developers and users of the components. The described mechanisms can significantly reduce the manual labor required to correctly implement thread-isolated execution patterns while preserving a familiar programming experience.

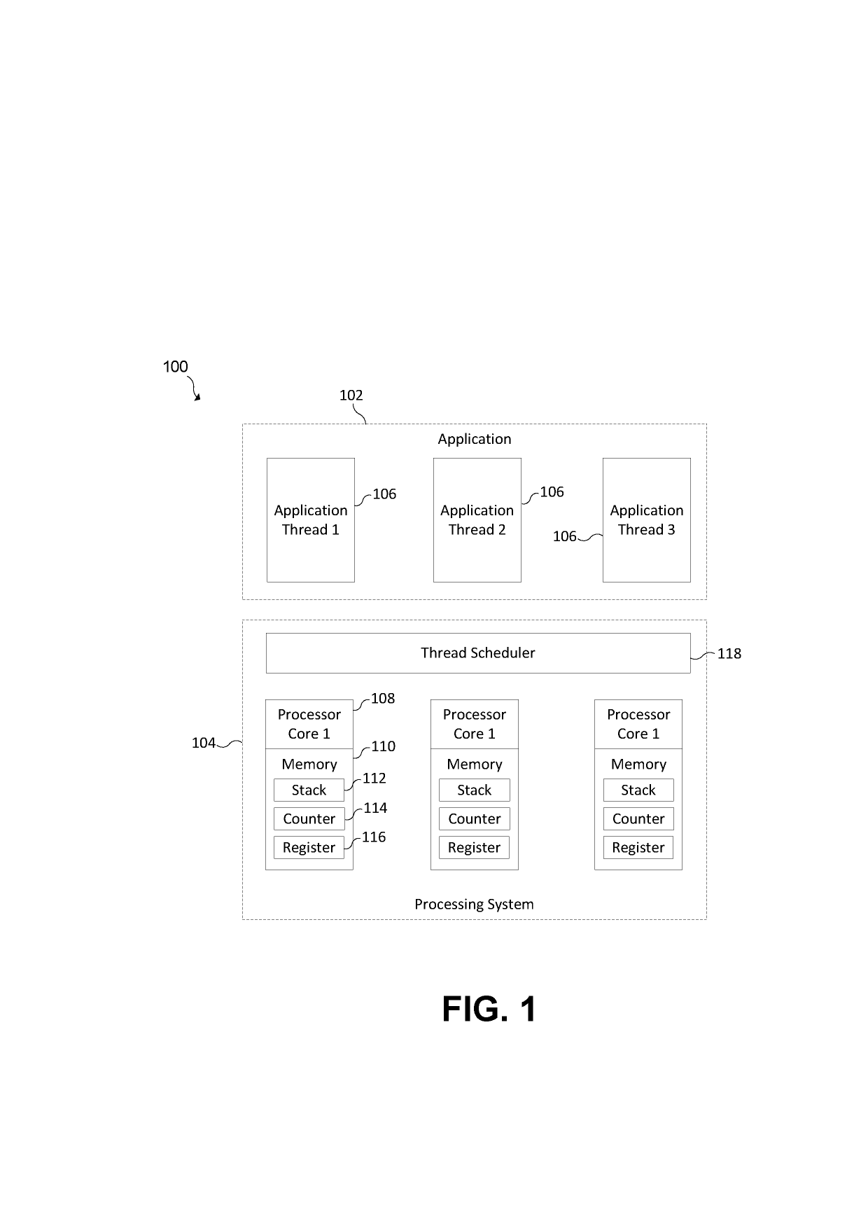

Referring now to FIG. 1, an example computing environment 100 is depicted upon which aspects of the disclosure may be implemented. The computing environment 100 of FIG. 1 shows an application 102 which is being executed by a processing system 104. In this example, the application 102 is capable of multithreaded execution. A thread is an independent unit of execution created within the context of the application being executed. Multithreading allows multiple threads to be executed independently and concurrently by the processing system. Multithreading is usually done to load balance and share system resources effectively or to achieve a target quality of service. The application can be divided into threads for multithreaded execution in any suitable manner. For example, applications can be divided into threads by a compiler which is capable of analyzing application code at compile time to identify code configurations and patterns which are suitable for parallelization according to various parallelization techniques. The compiler can then compile the application code into a machine-readable code capable of multithreaded execution by the processing system. In this example, the application has been divided into three threads 106. In practice, the number of threads an application is divided into can depend on several different factors including the functionality and design of the application, the capabilities of the system, the method of compiling the application into machine-readable code, and the like.

The processing system 104 includes multiple processor cores 108 which are configured to execute different threads concurrently. The processor cores 108 may be cores of a multiprocessor system (i.e., a computer system having multiple processors) and/or a multi-core system (i.e., a computer system having at least one processor with multiple processing cores). The processing system 104 is configured to provide a thread-isolated execution environment for executing the application 102 having compiler-enforced single-threadedness guarantees which prevent intentional sharing of data between threads. The processing system 104 includes a memory system 110 allocated to each thread for storing thread state and other data and for implementing data structures, such as a stack 112, a register 114, and/or a counter 116 for each thread. The processing system 104 also includes a thread scheduler 118 which schedules the execution of the threads 106 and selects the processor cores 108 to use to execute each thread 106. Scheduling is typically based at least in part on priority of the application and threads. Any suitable scheduling and/or prioritization scheme may be used.

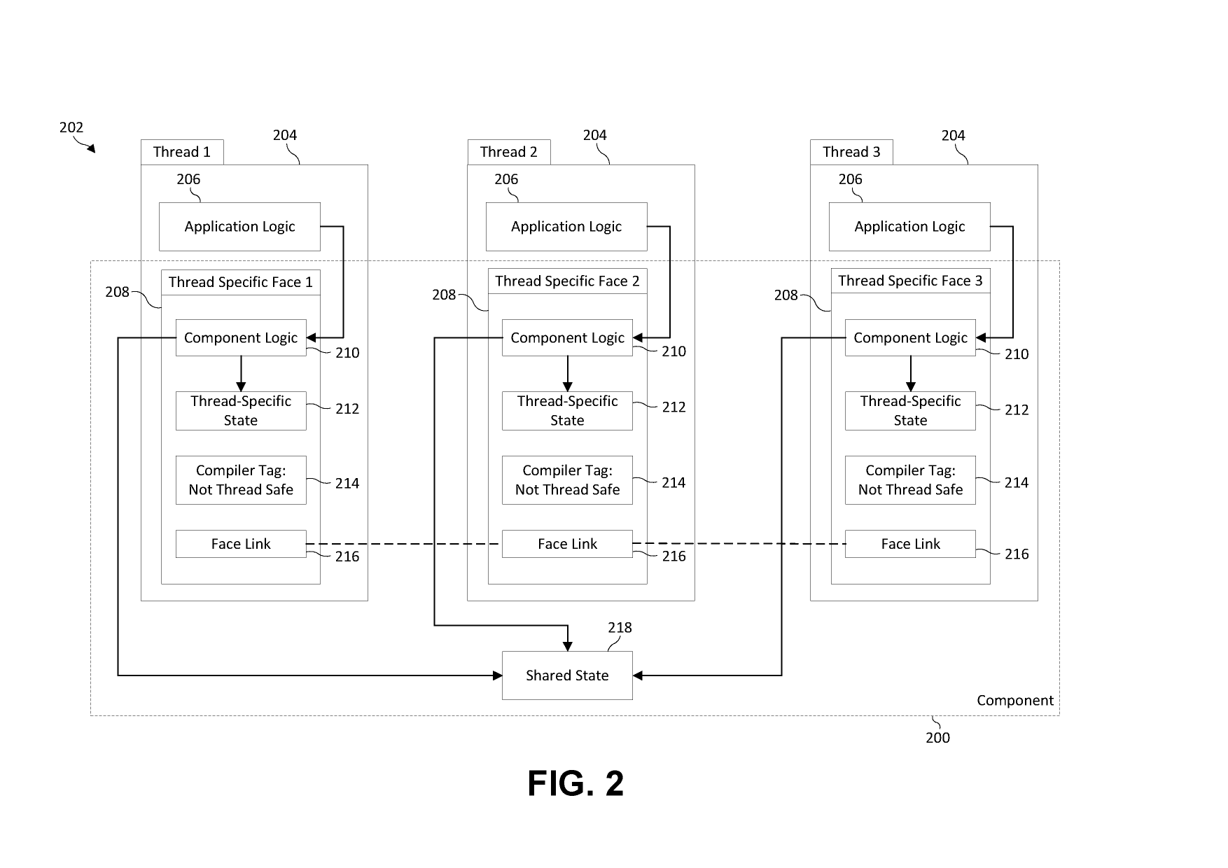

FIG. 2 shows an example implementation of a software component 200 that is used in an application 202. The application 202 is divided into multiple threads 204 for execution by a multithreaded processing system, such as the system 104 of FIG. 1. Each thread 204 includes application logic 206 which is the set of rules, processes, and workflows that define the behavior of the software application and how it will interact with other component and applications. Three threads 204 are shown in this example. In practice, applications can be divided into more or fewer threads for execution, as noted above. The software component 200 is a modular, self-contained unit of software that encapsulates specific functionality and can interact with other components through well-defined interfaces. It is designed to be reusable, replaceable, and independently deployable, enabling the development of complex systems by assembling multiple components. In this example, the component 200 is being utilized in a thread-isolated execution environment having compiler-enforced single-threadedness guarantees to prevent intentional sharing of data between threads. The thread-isolated execution environment prevents sharing by forcing application components to exist on a single thread.

As shown in FIG. 2, the software component 200 is implemented by generating a thread-specific face 208 in each thread in which the software component 200 is utilized. The multiple thread-specific faces 208, 210, 212 together form a single component 200. Although the software component is shown as being implemented across three threads of the application 202 in FIG. 2, there is essentially no limit to the number of threads the component may exist on. Each thread-specific face 208 includes component logic 210 which is the set of rules and operations within the component which define how the component processes data, interacts with other components, and performs its designated function. Each thread-specific face 208 also includes thread-specific state 212. Thread-specific state 212, also known as thread-local storage, can include any data, variables, and/or resources needed by the thread-specific face 208 during execution. The thread-specific state 212 is only accessible by the thread-specific face 208 for which it is implemented. Each face 208 is marked for the compiler as a single-threaded type which in turn enables compile-time protection against accidental data leakage across threads. In FIG. 2, this marking is represented by compiler tags 214 indicating that each face is “not thread safe.” The compiler tags 214 (or similar type of mechanism) prevent sharing by forcing the component to exist on a single thread. This ensures compile-time safety by preventing the thread-specific state of one thread being accessed from another thread which could lead to invalid memory access, data corruption due to lack of proper synchronization, or simply loss of performance, depending on the specific nature of the thread-specific state.

The software component 200 has mechanisms for sharing state across the threads in thread-isolated execution environments. These mechanisms are enabled in part by links, referred to as face links 216 in FIG. 2, which are embedded into each thread-specific face 208. These links 216 are established on top of a thread-local static variable which enables the group of thread-specific faces to act together as a single component (explained in more detail below). The linked faces 208 each have access to a shared state 218 which is provided in a separate memory or memory partition which is accessible to the threads. The shared state 218 includes any data, variables, or resources that each of the thread-specific faces 208 requires during execution and that must be the same for each face 208.

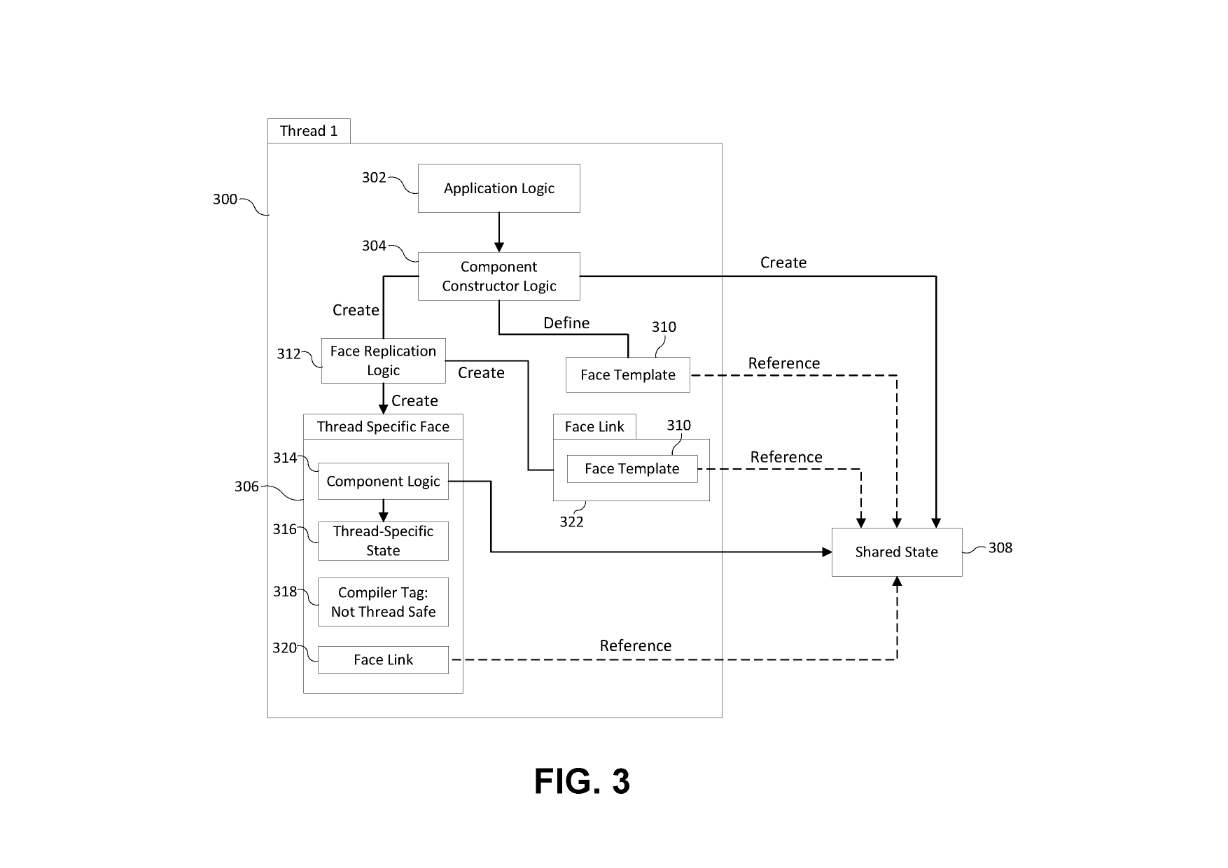

FIG. 3 depicts a diagram of a thread that shows an example of how a software component is first initialized in an application thread. The example of FIG. 3 shows an application thread 300 for an application. The application thread 300 includes application logic 302 which is the set of rules, procedures, functions, and the like which the application thread uses to perform one or more operations for the application. In this example, the application thread is programmed to generate a software component in accordance with this disclosure. To generate the software component, the application logic 302 includes component constructor logic 304 which includes code for beginning the process of generating a first thread-specific face 306 in the thread 300 for the software component. The component constructor logic 304 includes code for creating a shared state 308 for the first thread-specific face 306 which will be utilized by each iteration of the thread-specific face. The component constructor logic 304 also includes code for generating a predefined face template 310 which can be used to create later instances of the face type. The face template 310 captures all the shared state references required to create new faces linked with the existing family of faces that use the same shared state. The component constructor logic 304 includes face replication logic 312 which has the code for generating a thread specific face 306 having component logic 314 and thread-specific state 316. The face replication logic 312 includes code for adding a compiler tag 318 (or similar type of indicator) to the face 306 for indicating to the compiler that state created by the face 306 by the thread cannot be accessed by other threads. Any compiler tag capable of providing this indication to the compiler may be used. For example, in some implementations, the compiler tag is “not thread safe.”

To enable other instances of the same face type to be generated, a face link object 322 is generated in which the face template 310 is embedded. As described below, the link object 322 is included in an external global handle which can be accessed by other instances of the face type which are generated for the component. Although not shown in FIG. 3, the face template may also be embedded in the face link 320 of the first thread-specific face 306. Each face template 310 includes a reference to the shared state 308 for the first thread specific face and other instances of the same face type.

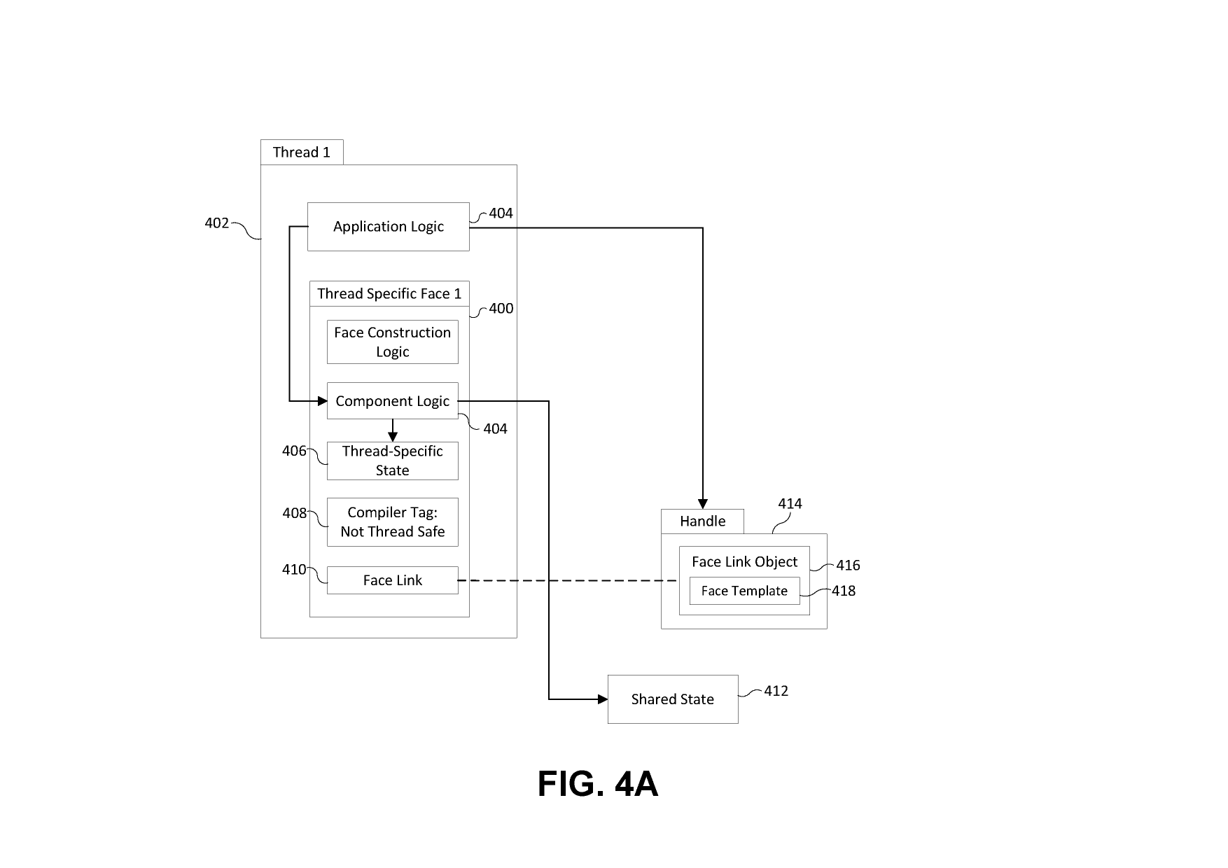

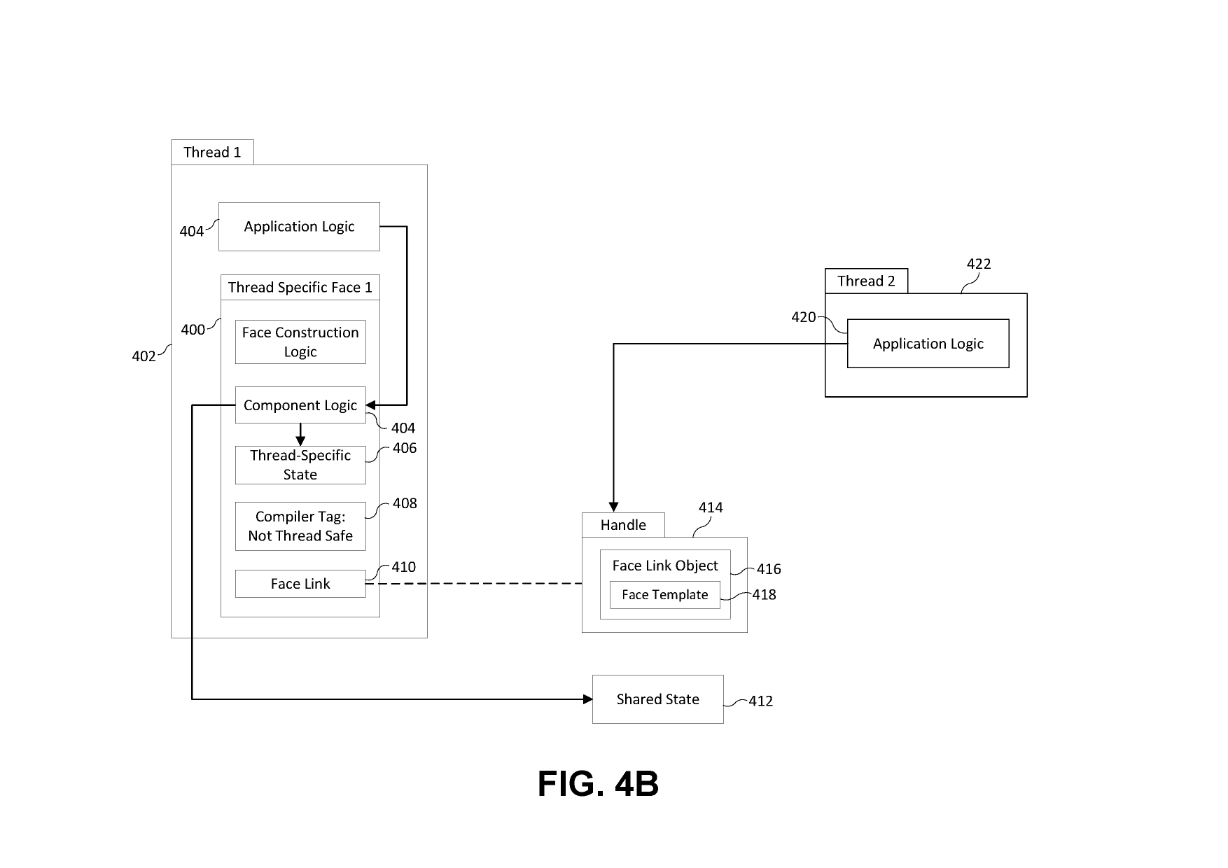

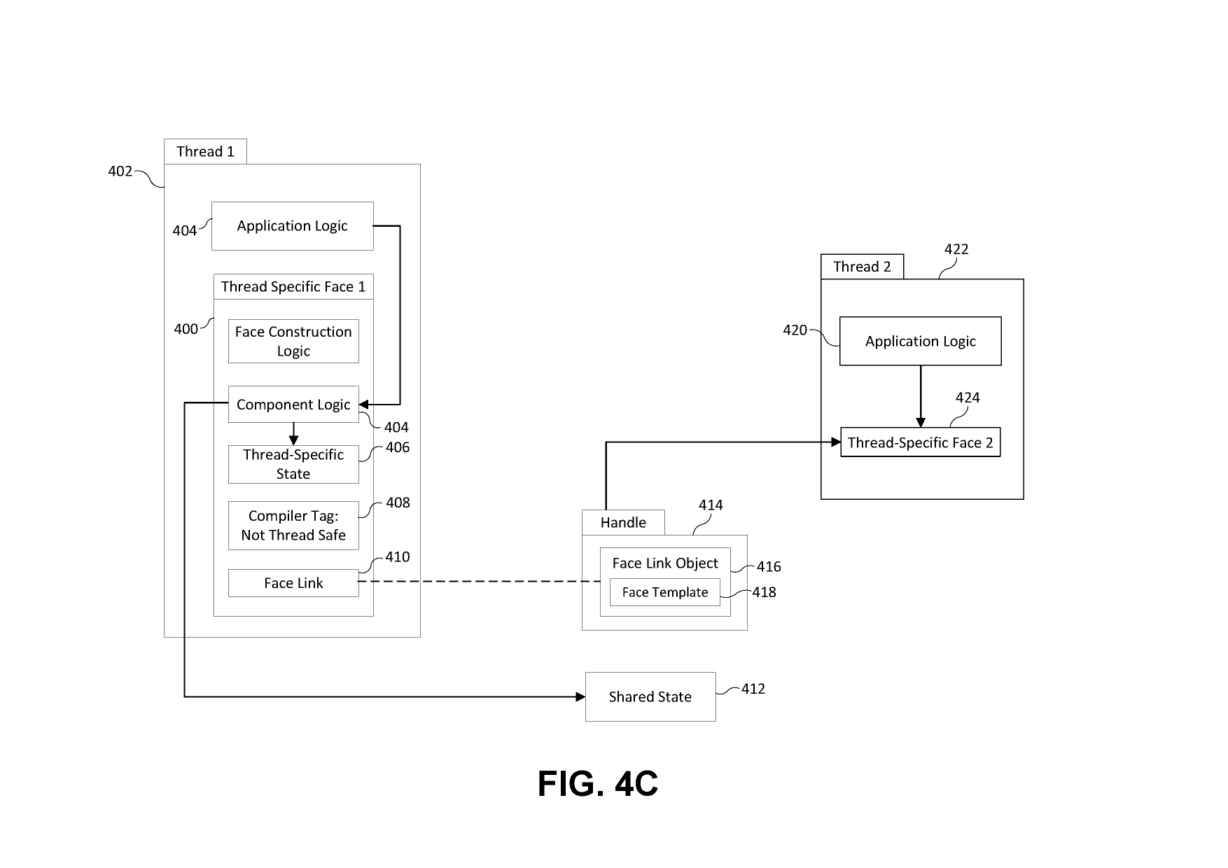

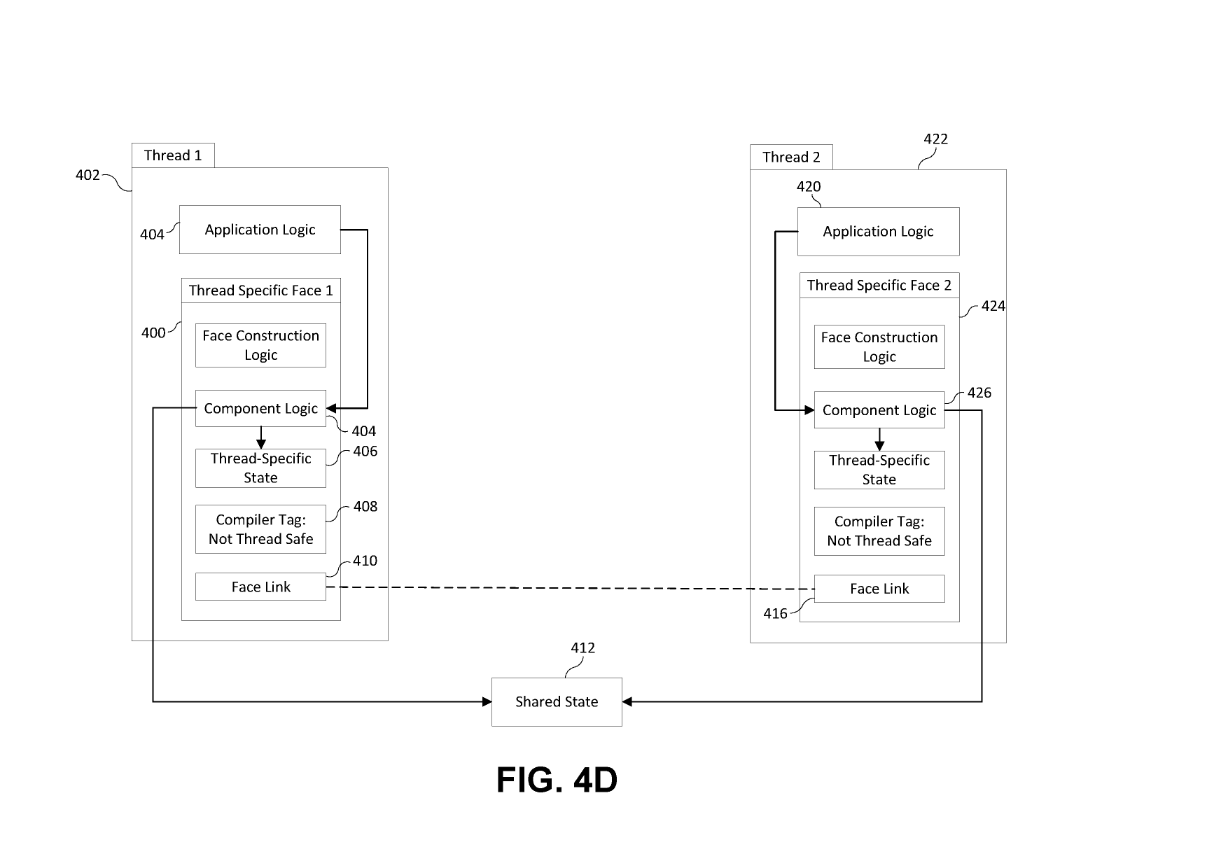

Referring now to FIGS. 4A-4D, example diagrams showing how a thread-specific face 400 can create new thread-specific faces of the same type which are linked together as a single family of linked objects. In FIG. 4A, a first thread-specific face 400 of a software component is generated in a first thread 402 in the manner described above with respect to FIG. 3. The first thread-specific face 400 includes component logic 404, thread-specific state 406, a compiler tag 408 (“Not thread safe”), and a face link 410 and has access to shared state 412. To generate a second thread-specific face, the application logic 404 of the first thread 402 creates a new global handle 414 that includes a face link object 416. Embedded in the face link object 416 is a face template 418 which can be used to generate new thread-specific faces of the same face type as the first thread-specific face 400. As shown in FIG. 4B, application logic 420 in a second thread 422 in which a new instance of the thread-specific face 400 is to be generated receives the handle 414 and, as shown in FIG. 4C, converts the handle 414 to a second thread-specific face 424 using the face template 418.

As noted above, the links between faces are established on top of a thread-local static variable which enables the thread-specific faces to be tied together as a single family of linked objects and which in turn enables the family of linked objects to utilize the same shared state. Programming languages typically express per-thread singletons via thread-local static variables, whereby the programming platform guarantees that logic accessing such a variable will access the instance specific intended for the current thread. In its natural state, thread-local variables do not facilitate the existence of links between peers on different threads. To establish the links, an intermediate layer is used to store a lazy-initialized handle in a global variable that links together the thread-local variables. On each thread, the thread-local variable is lazy-initialized from this global variable when creating a new face for the current thread. Thereafter, the linked object relationship is established, and all access of this variable is thread-local.

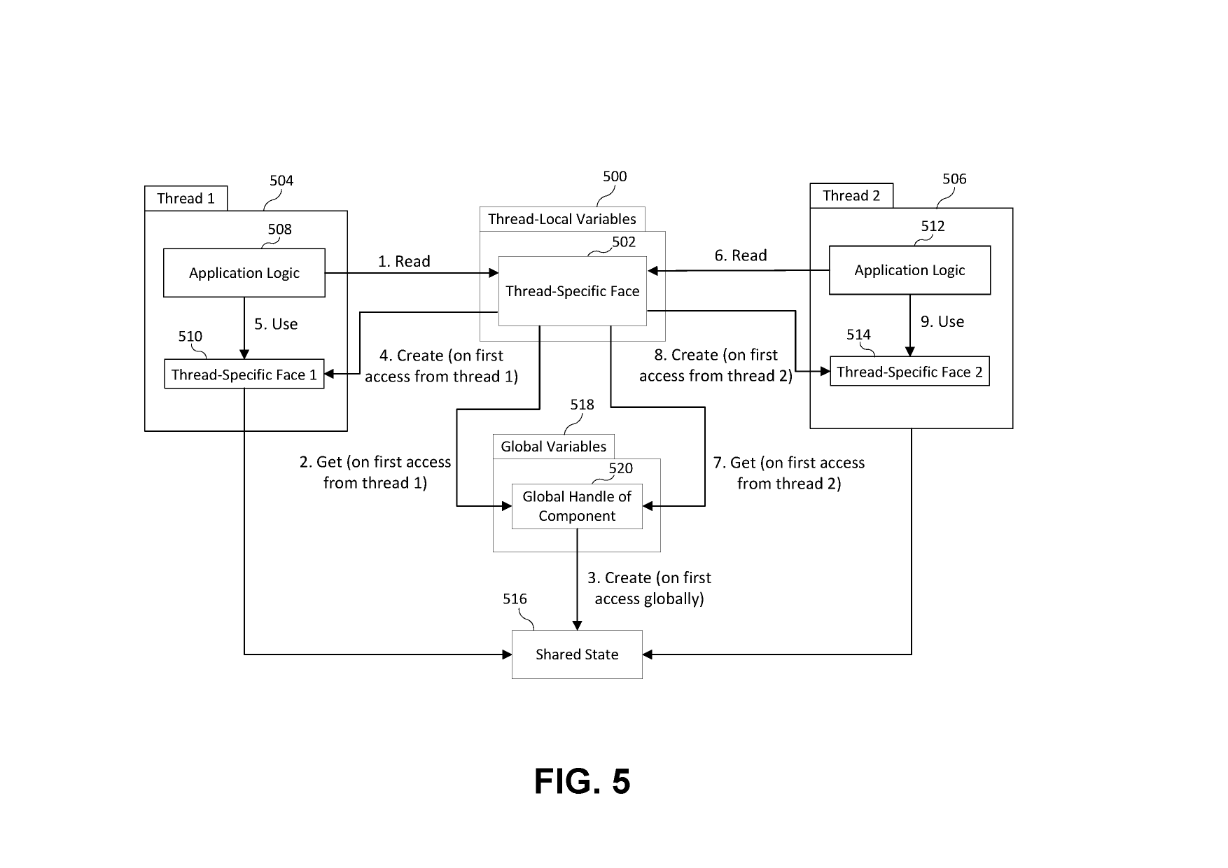

For example, referring to FIG. 5, a thread-local variables object 500 is established that includes a thread-specific face object 502 which is transferred to each new face that is generated from the same template. In the example of FIG. 5, there are two threads 504 and 506 for an application. The first thread 504 includes application logic 508 and a first thread-specific face 510 of a component. The second thread 506 includes application logic 512 and a second thread-specific face 514 for the component which is the same face type as the first thread-specific face 510. The first and second thread-specific faces 510, 514 each have access to shared state 516. In this example, an intermediate layer including a global variable object 518 stores a lazy-initialized global handle 520 for the component.

When the first thread-specific face 510 is first created by the application logic 508, the application logic 508 reads the thread-local variable for the first thread-specific face 510 from the thread-specific face object 502. The thread-specific face object 502 in turn accesses the global variable which lazy-initializes thread-local variable for the first thread-specific face 510 in the global variable 518. This also causes the shared state 516 to be created for the component. The first thread-specific face 510 is then created with a reference to the shared state. Similarly, when the application logic 512 begins to create the second thread-specific face, the application logic 512 reads the thread-specific face object 502. The thread-specific face object 502 in turn accesses the global variable 518 which lazy-initializes the thread-local variable for the second thread-specific face 514. The second thread-specific face is then created with a reference to the shared state 516. Thereafter, the linked object relationship is established, and all access of this variable is thread-local.

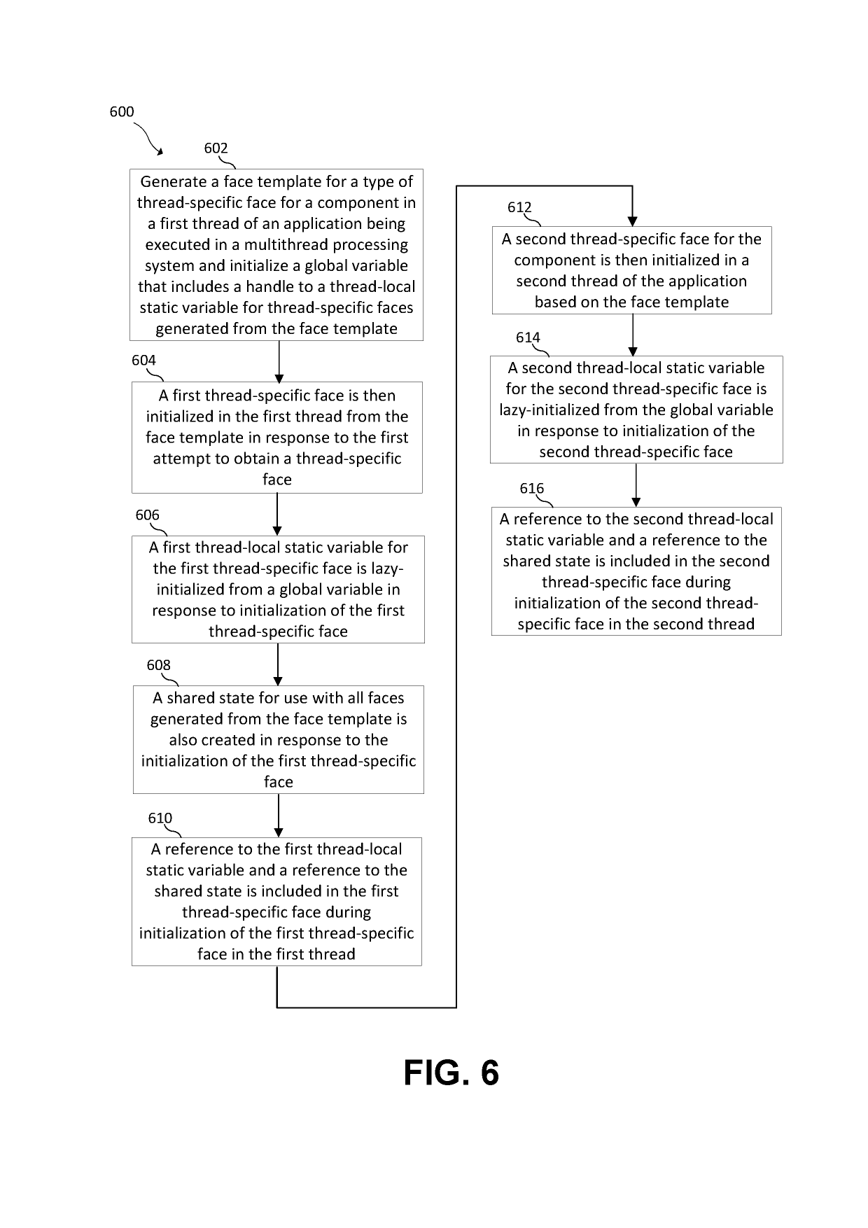

A flowchart of an example method of sharing state across threads in a thread-isolated execution environment with compile-time enforced safety guarantees is shown in FIG. 6. The method begins with generating a face template for a type of thread-specific face for a component in a first thread of an application being executed in a multithread processing system and initializing a global variable that includes a global handle to a thread-local static variable (block 602). A first thread-specific face is then initialized in the first thread from the face template in response to the first attempt to obtain a thread-specific face (block 604). A first thread-local static variable for the first thread-specific face is lazy-initialized from the global variable in response to initialization of the first thread-specific face (block 606). A shared state for use with all faces generated from the face template is also created in response to the initialization of the first thread-specific face (block 608). A reference to the first thread-local static variable and a reference to the shared state is included in the first thread-specific face during initialization of the first thread-specific face in the first thread (block 610). A second thread-specific face for the component is then initialized in a second thread of the application based on the face template (block 612). A second thread-local static variable for the second thread-specific face is lazy-initialized from the global variable in response to initialization of the second thread-specific face (block 614). A reference to the second thread-local static variable and a reference to the shared state is included in the second thread-specific face during initialization of the second thread-specific face in the second thread (block 616). The reference to the first thread-local static variable in the first thread-specific face and the reference to the second thread-local static variable in the second thread-specific face link the first thread-specific face and the second thread-specific face together to form a single component capable of sharing data via the shared state.

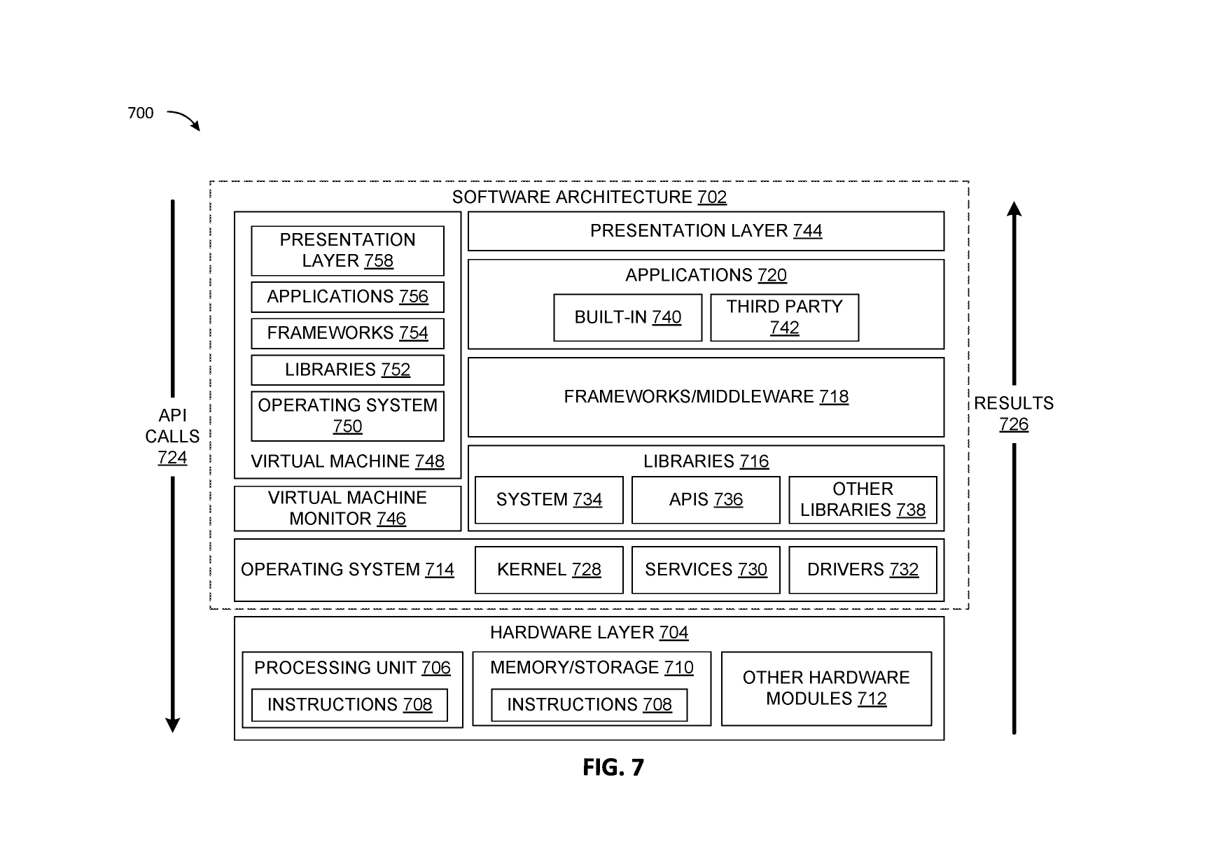

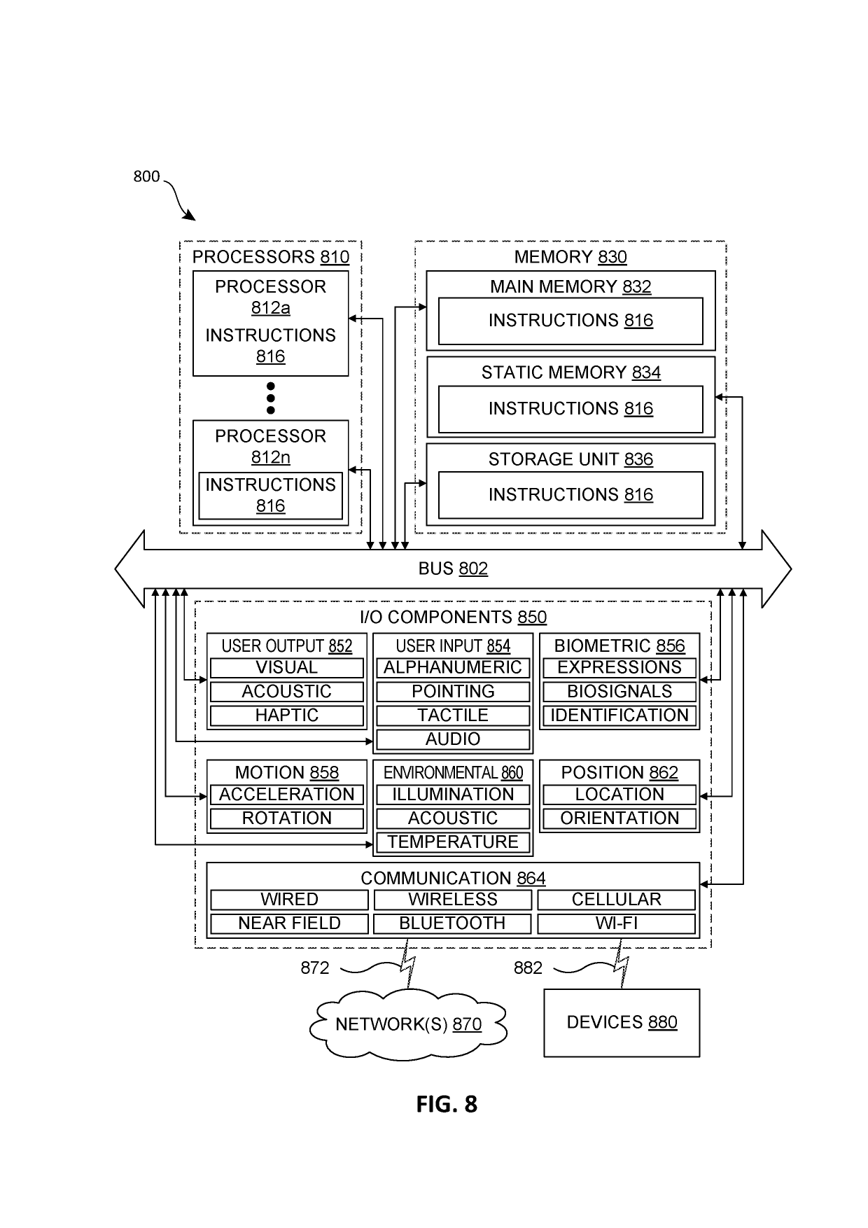

FIG. 7 is a block diagram 700 illustrating an example software architecture 702. This architecture may be used in each of the various services described above. Also, various portions of this architecture may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and Input/Output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than interacting directly with the OS 714. The libraries 716 may include system libraries 734 (for example, C standard library) that may provide functions such as memory allocation, string manipulation, and file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. The machine 800 may be used to implement any of the services described in the system above.

As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS.1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system for generating software components in a multithreaded processing environment that are capable of being executed in a thread-isolated manner to prevent data leakage across threads and that are linked together in a manner that enables the software components to share state, the data processing system comprising:
a processor; and
a memory in communication with the processor, the memory comprising executable instructions that, when executed by the processor alone or in combination with other processors, cause the data processing system to perform functions of:
generating a face template for a type of thread-specific face of a component in a first thread of an application being executed in the multithread processing system;
initializing a first thread-specific face in the first thread using the face template in response, the first thread-specific face having a first thread-specific state;
initializing a first thread-local static variable for the first thread-specific face from a global variable in response to initialization of the first thread-specific face;
allocating shared state for use with all faces generated from the face template in response to the initialization of the first thread-specific face;
including a reference to the first thread-local static variable and a reference to the shared state in the first thread-specific face during initialization of the first thread-specific face in the first thread;
initializing a second thread-specific face for the component in a second thread of the application based on the face template, the second thread-specific face having a second thread-specific state,
initializing a second thread-local static variable for the second thread-specific face is initialized from the global variable in response to initialization of the second thread-specific face; and
including a reference to the second thread-local static variable and the reference to the shared state in the second thread-specific face during initialization of the second thread-specific face in the second thread,
wherein the reference to the first thread-local static variable in the first thread-specific face and the reference to the second thread-local static variable in the second thread-specific face form a link between the first thread-specific face and the second thread-specific face that enables the first thread-specific face and the second thread-specific face to act together as a single component, and
wherein the first thread-specific face and the second thread-specific face are each executed in a thread-isolated manner to prevent thread-specific faces from accessing thread-specific states of other thread-specific faces so that data leakage across threads is prevented.

2. The data processing system of claim 1, wherein the first thread-local static variable and the second thread-local static variable are each lazy-initialized.

3. The data processing system of claim 2, wherein the face template includes a link to the shared state.

4. The data processing system of claim 3, wherein the link is constructed using the first thread-local static variable and the second thread-local static variable such that the link ties the first thread-specific face and the second thread-specific face together to form a family of linked objects that act together as a single component.

5. The data processing system of claim 1, wherein the face template causes the first thread-specific face and the second thread-specific face to each have a compiler tag indicating that the first thread-specific face and the second thread-specific face cannot be used by other threads.

6. The data processing system of claim 1, wherein the first thread-specific face and the second thread-specific face each have a thread-specific state that is separate from the shared state.

7. The data processing system of claim 1, wherein the global variable includes a thread-safe handle that links the first thread-local static variable and the second thread-local static variable together.

8. The data processing system of claim 7, wherein the first thread includes application logic that generates the first thread-specific face and the thread-safe handle.

9. A method for generating software components in a multithreaded processing environment that are capable of being executed in a thread-isolated manner to prevent data leakage across threads and that are linked together in a manner that enables the software components to share state sharing state across threads in a multithreaded processing environment, the method comprising:
generating a face template for a type of thread-specific face of a component in a first thread of an application being executed in a multithread processing system;
initializing a first thread-specific face in the first thread using the face template in response, the first thread-specific face having a first thread-specific state;
initializing a first thread-local static variable for the first thread-specific face from a global variable in response to initialization of the first thread-specific face;
creating a shared state for use with all faces generated from the face template in response to the initialization of the first thread-specific face;
including a reference to the first thread-local static variable and a reference to the shared state in the first thread-specific face during initialization of the first thread-specific face in the first thread;
initializing a second thread-specific face for the component in a second thread of the application based on the face template the second thread-specific face having a second thread-specific state;
initializing a second thread-local static variable for the second thread-specific face is lazy-initialized from the global variable in response to initialization of the second thread-specific face; and
including a reference to the second thread-local static variable and the reference to the shared state in the second thread-specific face during initialization of the second thread-specific face in the second thread,
wherein the reference to the first thread-local static variable in the first thread-specific face and the reference to the second thread-local static variable in the second thread-specific face form a link between the first thread-specific face and the second thread-specific face that enables the first thread-specific face and the second thread-specific face to act together as a single component, and
wherein the first thread-specific face and the second thread-specific face are each executed in a thread-isolated manner to prevent thread-specific faces from accessing thread-specific states of other thread-specific faces so that data leakage across threads is prevented.

10. The method of claim 9, wherein the first thread-local static variable and the second thread-local static variable are each lazy-initialized.

11. The method of claim 10, wherein the face template includes a link to the shared state.

12. The method of claim 11, wherein the link is constructed using the first thread-local static variable and the second thread-local static variable such that the link ties the first thread-specific face and the second thread-specific face together to form a family of linked objects that act together as a single component.

13. The method of claim 9, wherein the face template causes the first thread-specific face and the second thread-specific face to each have a compiler tag indicating that the first thread-specific face and the second thread-specific face are not thread-safe.

14. The method of claim 9, wherein the first thread-specific face and the second thread-specific face each have a thread-specific state that is separate from the shared state.

15. The method of claim 9, wherein the global variable includes a thread-safe handle that links the first thread-local static variable and the second thread-local static variable together.

16. The method of claim 15, wherein the first thread includes application logic that generates the first thread-specific face and the thread-safe handle.

17. A non-transitory computer readable medium on which are stored instructions that, when executed, cause a programmable device to perform functions of:
generating a face template for a type of thread-specific face of a component in a first thread of an application being executed in a multithread processing system;
initializing a first thread-specific face in the first thread using the face template in response the first thread-specific face having a first thread-specific state;
initializing a first thread-local static variable for the first thread-specific face from a global variable in response to initialization of the first thread-specific face;
creating a shared state for use with all faces generated from the face template in response to the initialization of the first thread-specific face;
including a reference to the first thread-local static variable and a reference to the shared state in the first thread-specific face during initialization of the first thread-specific face in the first thread;
initializing a second thread-specific face for the component in a second thread of the application based on the face template the second thread-specific face having a second thread-specific state;
initializing a second thread-local static variable for the second thread-specific face is lazy-initialized from the global variable in response to initialization of the second thread-specific face; and
including a reference to the second thread-local static variable and the reference to the shared state in the second thread-specific face during initialization of the second thread-specific face in the second thread,
wherein the reference to the first thread-local static variable in the first thread-specific face and the reference to the second thread-local static variable in the second thread-specific face form a link between the first thread-specific face and the second thread-specific face that enables the first thread-specific face and the second thread-specific face to act together as a single component, and
wherein the first thread-specific face and the second thread-specific face are each executed in a thread-isolated manner to prevent thread-specific faces from accessing thread-specific states of other thread-specific faces so that data leakage across threads is prevented.

18. The non-transitory computer readable medium of claim 17, wherein the first thread-local static variable and the second thread-local static variable are each lazy-initialized.

19. The non-transitory computer readable medium of claim 18, wherein the face template includes a link to the shared state.

20. The non-transitory computer readable medium of claim 19, wherein the link is constructed using the first thread-local static variable and the second thread-local static variable such that the link ties the first thread-specific face and the second thread-specific face together to form a family of linked objects that act together as a single component.
